(19) United States
(12) Patent Application Publication
(10) Pub. No.: US 2025/0038225 A1
(43) Pub. Date: Jan. 30, 2025

(54) SEPARATOR PLATE FOR AN ELECTROCHEMICAL SYSTEM AND CORRESPONDING ELECTROCHEMICAL SYSTEM COMPRISING SUCH A SEPARATOR PLATE

(71) Applicant: Reinz-Dichtungs-GmbH, Neu-Ulm (DE)

(72) Inventors: Christian LUKSCH, Altenstadt (DE); André SPEIDEL, Senden-Willenstetten (DE); Felix SENF, Neu-Ulm (DE)

(21) Appl. No.: 18/785,863

(22) Filed: Jul. 26, 2024

(30) Foreign Application Priority Data
Jul. 28, 2023 (DE) 20 2023 104 272.4

(51) Int. Cl. H01M 8/0297; H01M 8/0206; H01M 8/0254; H01M 8/026

(52) U.S. Cl. CPC H01M 8/0297; H01M 8/0206; H01M 8/0254; H01M 8/026

(57) ABSTRACT

The present disclosure relates to a separator plate for an electrochemical system, comprising a first plate and a second plate connected at a contact zone. The first plate comprises two first channels for conducting media, which run next to one another and are separated at least in sections by a web formed between the first channels. The second plate comprises a second channel for conducting media. The web formed between the first channels is lower in the crossing region of the second channel such that the first channels running on either side of the web are fluidically connected by a lower portion of the web. In or near the lower portion, the first plate is connected to the base of the second channel by a welded joint. The welded joint forms an end crater spaced away from a first end and a second end of the welded joint.

### CROSS REFERENCE TO RELATED APPLICATION

The present application claims priority to German Utility Model Application No. 20 2023 104 272.4, entitled “SEPARATOR PLATE FOR AN ELECTROCHEMICAL SYSTEM AND CORRESPONDING ELECTROCHEMICAL SYSTEM COMPRISING SUCH A SEPARATOR PLATE”, filed Jul. 28, 2023. The entire contents of the above-identified application is hereby incorporated by reference for all purposes.

### TECHNICAL FIELD

The present disclosure relates to a separator plate for an electrochemical system and to an electrochemical system comprising such a separator plate.

### BACKGROUND AND SUMMARY

Known electrochemical systems, for example fuel cell systems or electrochemical compressor systems, redox flow batteries and electrolyzers, usually comprise a plurality of separator plates which are arranged in a stack, such that in each case two adjacent separator plates enclose an electrochemical cell. The separator plates usually each comprise two individual plates which are connected to one another along their rear sides facing away from the electrochemical cells. The separator plates can be used, for example, for electrically contacting the electrodes of the individual electrochemical cells (e.g. fuel cells) and/or for electrically connecting adjacent cells (series connection of the cells). In the case of fuel cells, bipolar plates are often used as separator plates.

The individual plates of the separator plates may comprise channel structures for supplying the cells with one or more media and/or for transporting media away from the cells. The media may for example be fuels (e.g. hydrogen or methanol), reaction gases (e.g. air or oxygen) or a coolant as fed media and reaction products and heated coolant as discharged media. Furthermore, the separator plates may serve for transferring the waste heat produced in the electrochemical cell, as is produced for instance during the conversion of electrical or chemical energy in a fuel cell, and may be configured to seal the various media channels or cooling channels in relation to one another and/or towards the outside. In the case of fuel cells, the reaction media, e.g fuel and reaction gases, are normally conducted on the mutually averted surfaces of the individual plates, while the coolant is conducted between the individual plates. The electrochemical cells in particular of a fuel cell may for example each comprise a membrane electrode assembly (or MEA) with a respective polymer electrolyte membrane (PEM) and electrodes. The MEA may also comprise one or more gas diffusion layers (GDL) which are normally oriented towards the separator plates, such as towards bipolar plates of fuel cell systems, and are for example in the form of a carbon felt.

The construction and the function of the individual plates often require the channels of the individual plates of the same separator plate to run in a crossed manner relative to one another at least in certain regions, such that the rear sides of the channel bases can be brought into contact and connected only in the crossing regions. If the individual plates are connected in the region of the crossing channels, such an arrangement thus places high demands on the accuracy of the positioning of the individual plates relative to one another and on the positioning of the instrument provided for forming the connection relative to the individual plates. Conventional methods for connecting the individual plates to one another are, for example, welding, laser welding, soldering or adhesive bonding. If the required accuracy of the positioning is not observed when connecting the individual plates, the offset causes the connections to be too weak or to be entirely absent at least in part. The pressure of the coolant conducted between the individual plates may then result in tearing of the connections, these tearing open for example between the plates or for example a weld plug being torn from one or both individual plates, such that a hole is produced at least in one plate. If the joint is designed as a welded joint, the rapid cooling of the weld pool typically results in a so-called end crater at the end of a weld seam. Especially in the region of the end crater, star-shaped cracks can occur, which can lead to immediate leakage or reduced durability. Additionally or alternatively, the offset can lead to too much energy being introduced into one point of an individual plate and burning through it, also creating a hole. The individual plates may thus be damaged along the connecting locations to the point of becoming unusable. This can result in the electrochemical cells enclosed between adjacent separator plates being flooded with a cooling fluid that is conducted between the individual plates and passes through the cracks in the individual plates. A direct uncontrolled reaction between the reaction media may also occur if both individual plates comprise holes. Both can result in failure of the entire stack. The methods used hitherto for connecting the individual plates in regions in which the channels of the individual plates run in a crossed manner can therefore entail a high number of rejects in production or a short service life of the system in operation.

The present disclosure is thus based on the object of providing a separator plate for an electrochemical system, said separator plate being as stable as possible even in a region in which the channels of the individual plates of the separator plate run in a crossed manner relative to one another and being able to be produced with the lowest possible number of rejects.

This object is achieved by means of a separator plate for an electrochemical system and an electrochemical system according to the present disclosure.

Correspondingly, a separator plate for an electrochemical system is proposed. The separator plate comprises a first individual plate and a second individual plate which is connected to the first individual plate, wherein the two individual plates contact one another in a contact zone.

The first individual plate comprises two first channels for conducting media which are formed into the first individual plate, which run next to one another and which are separated from one another at least in sections by a web formed between the first channels.

The second individual plate comprises a second channel for conducting media which is formed into the second individual plate, wherein the web formed between the first channels, and the second channel formed into the second individual plate are configured and arranged in such a way that a projection of the second channel onto the first individual plate perpendicular to the planar face plane of the first individual plate crosses the web along a crossing region of the web.

The web is lower in the crossing region of the web, such that the first channels running on either side of the web are fluidically connected by way of the lower portion of the web. Provision is furthermore made for a rear side of the first individual plate, said rear side facing the second individual plate, in the region of the lower portion or in a region adjoining the lower portion, to be connected to a rear side of the base of the second channel, said rear side facing the first individual plate, in the contact zone of the individual plates by means of a welded joint. For example, a rear side of the base of the lower portion, said rear side facing the second individual plate, may be connected to the rear side of the base of the second channel, said rear side facing the first individual plate, in the contact zone of the individual plates by means of the welded joint.

The welded joint extends longitudinally from a first end located in a first end region to a second end located in a second end region. The welded joint between the first end and the second end forms an end crater. The end crater is spaced from the first end of the welded joint and from the second end of the welded joint.

Instead of using the formulation according to which a projection of the channels and/or webs of the second individual plate onto the first individual plate crosses the webs and/or the channels of the first individual plate or vice versa, for the sake of simplicity the shorter formulation according to which the channels and/or the webs of the second individual plate cross the webs and/or the channels of the first individual plate or vice versa will be used in some instances in the following text. However, this should always be understood to mean that the mutually crossing webs and channels of the two individual plates in each case run in different planes at least in sections, these planes being oriented predominantly parallel to one another. Unless otherwise stated, the planes of individual plates refer to their neutral fibers.

Due to the fact that the web separating the first channels is lower at the point where it crosses the second channel and that a rear side of the base of the lower portion, said rear side facing the second individual plate, is connected to a rear side of the base of the second channel, said rear side facing the first individual plate, in a materially bonded manner, the region in which the two individual plates are or can be connected is increased in size. In this way, there is more space for the mentioned welded joint, as a result of which the latter is larger than in conventional separator plates for stabilization of the separator plate.

In pressure pulsation tests, in which a medium is forced between the individual layers of the separator plate at high and alternating pressure in order to examine the durability of separator plates, it has been shown that a welded joint can develop tears or can even completely tear open in its end regions, that is to say at the start and/or at the end of the welded joint, where the welding tool starts up or shuts down. This tearing open is sometimes also referred to as peeling of the welded joint and often has a negative influence on the service life of the separator plate. The end regions are thus often weak points of the welded joint.

The ends of the welded joint can be subjected to greater stress than regions of the welded joint that lie between the ends of the welded joint, particularly in the case of pulsating compressive stress caused by coolant conducted between the individual plates. The proposed design of the welded joint has the advantage that the region of the end crater, in which the welded joint typically has weaker joint properties, is at a distance from the particularly stressed ends of the welded joint. In this way, cracks and the resulting leaks can be reduced or even prevented.

In one embodiment, the welded joint can be designed in such a way that it does not form an end crater in the first end region and/or in the second end region.

The first end region of the welded joint can be defined as the region extending from the first end of the welded joint in the direction of the second end of the welded joint. The first end region can extend from the first end of the welded joint to immediately adjacent to the end crater. The second end region can be defined as the region that extends from the second end of the welded joint in the direction of the first end of the welded joint. The second end region can extend from the second end of the welded joint to immediately adjacent to the end crater. Alternatively, the end region can be defined by the region of the welded joint where the welding tool or welding laser beam is applied. Accordingly, the end region can be called the approach region of the welding tool or the welding laser beam. As the welding tool approaches, the two individual plates may not be completely welded together locally in the end region compared to the rest of the welded joint, for example.

The welded joint can comprise a first weld seam and a second weld seam that at least partially overlap. The end crater can be arranged in an overlap region. The overlap region can be defined as a region in which the first weld seam at least partially overlaps the second weld seam. For example, a length of the first and/or second end region can correspond to at most twenty times the length of the end crater in the overlap region, optionally at most fifteen times the length of the end crater in the overlap region, or optionally at most twelve times the length of the end crater in the overlap region. For example, a length of the first and/or second end region can be at least 100% of the length of the end crater in the overlap region, optionally at least 150% of the length of the end crater in the overlap region, or optionally at least 200% of the length of the end crater in the overlap region. The first and/or second end region can have a length that essentially corresponds to the length of the end crater in the overlap region. The length can be measured on the side of the component on which the laser beam enters the component during the production of the welded joint.

In one embodiment, the end crater may be located in the central 85% between, and in particular in the central 70% between, the first and second ends of the welded joint. An arrangement of the end crater in a central region between the first and second ends of the welded joint can have the advantage that the end crater is spaced from the particularly stressed ends of the welded joint.

In one embodiment, the welded joint may have imbricated weld solidification lines which as a whole extend in the first direction in the first end region, for example in a region from the first end of the welded joint to the end crater. The welded joint can have imbricated weld solidification lines in the second end region, such as in a region from the second end of the welded joint to the end crater, which extend in a second direction opposite to the first direction.

In one embodiment, the first weld seam may extend from the first end of the welded joint towards the second end of the welded joint, encompassing the end crater and beyond the end crater. The second weld seam can extend from the second end of the welded joint in the direction of the first end of the welded joint, encompassing the end crater, to an end of the end crater facing the first end of the welded joint.

It should be noted that in the present disclosure, the end crater may be defined such that a welding mirror is encompassed by the end crater.

The welded joint can be formed by welding the first weld seam in a first direction, wherein an end crater of the first weld seam is formed at the end of the first weld seam. The second weld seam can then be welded in a second direction, in the opposite direction to the first. The second weld seam can at least partially overlap the first weld seam. The end crater of the first weld seam can be traversed by the second weld seam during the production of the welded joint in such a way that the end crater of the second weld seam at least partially overlaps the end crater of the first weld seam or, optionally, lies directly next to the traversed end crater of the first weld seam along the welded joint or lies at a distance next to the traversed end crater of the first weld seam along the welded joint.

The end crater of the second weld seam can form the end crater of the welded joint described above.

In one embodiment, the welded joint can be designed in such a way that the first weld seam at least partially overlaps the second weld seam in the overlap region. The center lines of the first and second weld seams can be directly above each other or at a distance from each other. For example, a distance between the center line of the first weld seam and the center line of the second weld seam can be at most 25%, at most 20%, or at most 15% of a width of the first and/or second weld seam. The width of the weld seam refers to the actual width of the weld seam, not the width spanned by a curved section of the weld seam.

The end crater can have a distance to the first end and/or the second end of the welded joint of at least 20% or at least 50%, and/or a maximum of 1000% or a maximum of 800% of the width of the first and/or second weld seam.

The end crater can have a length that corresponds to at least 25% or at least 40%, and/or at most 600%, at most 400%, or at most 250% of the width of the first and/or second weld scam.

The first weld seam can have imbricated weld solidification lines the imbricated pattern of which extends in the first direction, at least in sections, and the second weld seam can have imbricated weld solidification lines the imbricated pattern of which extends in the second direction, at least in sections, with the second direction being opposite to the first direction. In particular, the first weld seam only shows the imbricated weld solidification lines with the imbricated pattern extending in the first direction in regions that are not overlapped by the second weld seam.

The overlap region can have a length that corresponds to at least 400%, at least 500%, or at least 600% of the length of the end crater. The overlap region can have a length that corresponds to at least 10% of the length of the welded joint or at least 20% of the length of the welded joint or at least 30% of the length of the welded joint.

The overlap region can have a length that corresponds to a maximum of 80% or a maximum of 60% or a maximum of 50% or a maximum of 40% or a maximum of 35% of the length of the welded joint.

In one embodiment, the welded joint can comprise at least one straight section or have a straight course. For example, the entire welded joint can run in a straight line. Alternatively, a first section of the welded joint can run along a first straight line and a second section of the welded joint can run along a second straight line. The first weld seam can run completely or partially along the first straight line. The second weld seam can run completely or partially along the second straight line. The first straight line can run essentially parallel, optionally exactly parallel, to the second straight line. The first and second straight lines can be offset to the side.

The welded joint may have a first curved portion, wherein the first curved portion extends and is curved such that a virtual straight line extending perpendicularly through the first end region intersects the welded joint at least twice. Alternatively or additionally, the welded joint may have a second curved section, wherein the second curved section extends and is curved in such a way that a virtual second straight line extending vertically through the second end region intersects the welded joint at least twice. The welding geometry can therefore be designed in such a way that a further section of the welded joint, usually the curved section, runs next to the relevant end region, which can stabilize or stiffen the end region of the welded joint.

The welded joint can be a laser welded joint. Laser welded joints can be produced in a particularly precise manner. However, the present document is not limited to laser welded joints.

The welded joint can be designed as a continuous welded joint, e.g without interruptions. The separator plate, for example a distribution and/or collection region of the separator plate, can have a plurality of such welded joints. In one example, the separator plate only has corresponding welded joints in the distribution and/or collection region, but not in the electrochemically active region.

In some embodiments, at least one of the end regions and, for example, an associated curved section merge continuously into one another. For example, it may be provided that the first end region adjoins the first curved section or is part of the first curved section and/or that the second end region adjoins a second curved section or is part of the second curved section.

The welded joint can have a shape that is designed in such a way that it can be formed by applying a welding tool and/or welding laser beam at most one time. This can have the advantage that the welded joint only has one end crater. Alternatively, the welded joint can have a shape that is designed in such a way that it can be formed by repeatedly applying a welding tool and/or welding laser beam. An end crater of a previously executed weld seam can be traversed by a subsequently executed weld seam.

As a rule, each individual plate comprises at least one through-opening for the passage of a fluid, an electrochemically active region and at least one distribution or collection region, which fluidically connects a through-opening to the electrochemically active region. The first channels are often arranged in the distribution or collection region of the first individual plate and the second channel in the distribution or collection region of the second individual plate and-viewed in orthogonal projection onto a common plane parallel to the plate plane-run at an angle to each other. Whether a distribution or collection region is a distribution region or a collection region can usually only be determined during operation, as symmetrical, for instance point-symmetrical designs are often selected.

The above-described separator plate is often called bipolar plate in applications in a fuel cell system.

Furthermore, an electrochemical system is proposed which comprises a plurality of stacked separator plates or bipolar plates of the type described above.

In a further aspect, a method for producing a separator plate of the type described above is proposed. The method comprises the following steps:
providing a first individual plate having two first channels for guiding media, which are formed in the first individual plate, run next to one another and are separated from one another at least in sections by a web formed between the first channels;
providing a second individual plate having a second channel formed in the second individual plate for media guidance;
arranging the first and second plates such that a projection of the second channel onto the first individual plate perpendicular to the plane of the first individual plate crosses the web along a crossing region of the web; wherein the web is lowered in the crossing region of the web so that the first channels extending on both sides of the web are in fluid communication via the lowering of the web, and
connecting a rear side of the bottom of the countersink facing the second individual plate by means of a welded joint in the contact zone of the individual plates to a rear side of the bottom of the second channel facing the first individual plate, the welded joint being designed such that the welded joint extends longitudinally from a first end located in a first end region to a second end located in a second end region and the welded joint forms an end crater between the first end and the second end and the end crater is spaced from the first end and from the second end.

In step IV, a first weld seam can be welded along a first direction. A second weld seam can be welded in the second direction, opposite to the first direction, with the second weld seam overlapping the first weld seam in an overlap region.

An end crater of the first weld seam can be at least partially, optionally completely, traversed by the second weld seam. In this way, a continuous welded joint can be generated that has only one end crater, which is spaced from the first end of the welded joint and from the second end of the welded joint.

Exemplary embodiments of the separator plate and of the electrochemical system are illustrated in the figures and will be explained in more detail on the basis of the following description.

### BRIEF DESCRIPTION OF THE FIGURES

FIG. 1 schematically shows a perspective illustration of an electrochemical system comprising a plurality of separator plates or bipolar plates arranged in a stack.

FIG. 2 schematically shows a perspective illustration of two bipolar plates of the system according to FIG. 1 with a membrane electrode assembly (MEA) arranged between the bipolar plates.

FIG. 3 schematically shows a section through a plate stack of a system in the manner of the system according to FIG. 1.

FIG. 4A schematic section of a top view of a collection or distribution region of a separator plate, whereby channels and webs of a rear side of the separator plate are made visible.

FIG. 4B schematically shows a sectional illustration of the section A-A indicated in FIG. 4A.

FIG. 5 schematically shows a section of a top view of a separator plate comprising a first individual plate and a second individual plate, wherein channels of both individual plates are made visible and the first individual plate is connected to the second individual plate by means of a welded joint.

FIGS. 6A-6C show various embodiments of a welded joint.

FIG. 6C′ schematically shows a height profile along the section B-B indicated in FIG. 6C through the end crater of FIG. 6C.

FIG. 7 shows a section of a top view of an individual plate of a separator plate comprising a welded joint according to FIG. 6A looking from a beam entry side.

FIG. 8 shows a section of a top view of an individual plate of a separator plate comprising a welded joint as shown in FIG. 6A, looking from a rear side.

FIG. 9 schematically shows a section through the welded joint of the separator plate of FIGS. 4A and 4B in a region where there is no end crater.

FIG. 10 schematically shows a section through the welded joint of the separator plate of FIGS. 4A and 4B in a region where an end crater is located.

### DETAILED DESCRIPTION

Here and below, features that recur in different figures are denoted in each case by the same or similar reference signs.

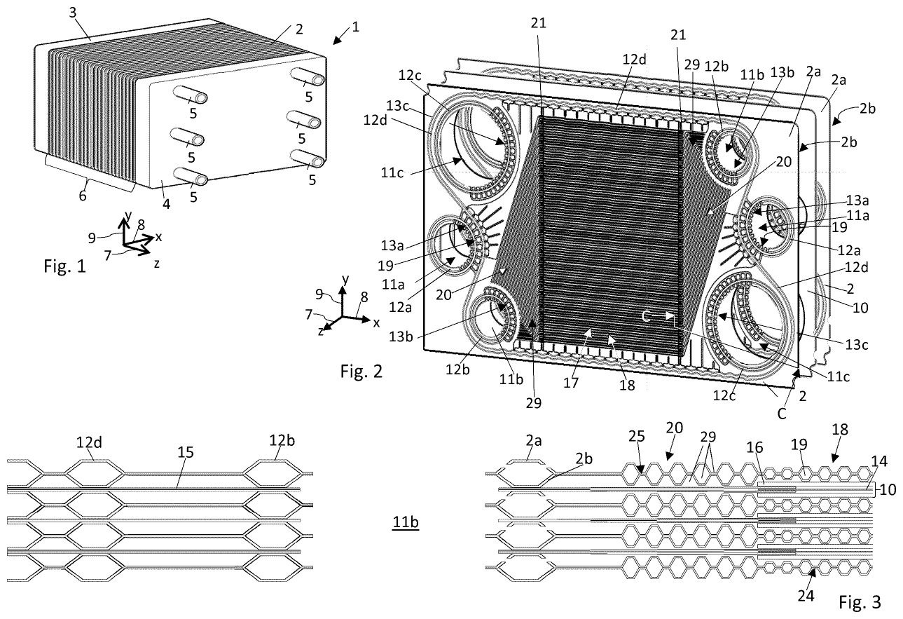

FIG. 1 shows an electrochemical system 1 comprising a plurality of structurally identical metallic separator plates or bipolar plates 2 which are arranged in a stack 6 and are stacked in a z-direction 7. The bipolar plates 2 of the stack 6 are clamped between two end plates 3, 4. The z-direction 7 is also called stacking direction. In the present example, the system 1 is a fuel cell stack. In each case two adjacent bipolar plates 2 of the stack enclose between them an electrochemical cell which serves, for example, for conversion of chemical energy into electrical energy. In order to form the electrochemical cells of the system 1, a respective membrane electrode assembly (MEA) is arranged between adjacent bipolar plates 2 of the stack (see for example FIG. 2). The MEAs typically each contain at least one membrane, e.g. an electrolyte membrane. A gas diffusion layer (GDL) may also be arranged on one or both surfaces of the MEA (not illustrated in FIGS. 1 and 2).

In alternative embodiments, the system 1 may equally be in the form of an electrolyzer, an electrochemical compressor or a redox flow battery. In these electrochemical systems, use may likewise be made of separator plates. The construction of these separator plates may then correspond to the construction of the separator plates 2 which are explained in more detail here, even though the media conducted on or through the separator plates in the case of an electrolyzer, in the case of an electrochemical compressor or in the case of a redox flow battery may differ in each case from the media used for a fuel cell system.

The z-axis 7 together with an x-axis 8 and a y-axis 9 defines a right-handed Cartesian coordinate system. The separator plates 2 each define a plate plane, each of the plate planes of the individual plates being oriented parallel to the x-y plane and thus perpendicular to the stacking direction or to the z-axis 7. The end plate 4 comprises a plurality of media connections 5, via which media can be fed to the system 1 and via which media can be discharged from the system 1. These media which can be fed to the system 1 and which can be discharged from the system 1 may comprise, for example, fuels such as molecular hydrogen or methanol, reaction gases such as air or oxygen, reaction products such as water vapor, or depleted fuels or coolants such as water and/or glycol.

FIG. 2 shows, in perspective form, two adjacent separator plates 2 of an electrochemical system of the type of the system 1 of FIG. 1 and a membrane electrode assembly (MEA) 10 known from the prior art which is arranged between these adjacent separator plates 2, the MEA 10 being largely concealed in FIG. 2 by the separator plate 2 facing the observer. The separator plate 2 is formed from two individual plates 2a, 2b which are joined together in a materially bonded manner (see for example FIG. 3), of which only the first individual plate 2a which faces the observer and which conceals the second individual plate 2b is visible in FIG. 2. The individual plates 2a, 2b may each be manufactured from a metal sheet, e.g. from a stainless steel sheet. The individual plates 2a, 2b may, for example, be welded to one another, e.g. by laser welded joints.

The individual plates 2a, 2b comprise through-openings which are aligned with one another and which form through-openings 11a-c in the separator plate 2. When a plurality of separator plates of the type of the separator plate 2 are stacked, the through-openings 11a-c form lines which extend in the stacking direction 7 through the stack 6 (see FIG. 1). Typically, each of the lines formed by the through-openings 11a-c is fluidically connected to one of the ports or media connections 5 in the end plate 4 of the system 1. By way of the lines formed by the through-openings 11a, it is possible for e.g. coolant to be introduced into the stack or discharged from the stack. By contrast, the lines formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are substantially parallel to the plate plane.

In order to seal the through-openings 11a-c in relation to the interior of the stack 6 and in relation to the environment, the first individual plates 2a each comprise sealing arrangements in the form of sealing beads 12a-c which are each arranged around the through-openings 11a-c and which each completely enclose the through-openings 11a-c. The second individual plates 2b comprise, on the rear side of the separator plates 2 which faces away from the observer in FIG. 2, corresponding sealing beads for sealing the through-openings 11a-c (not shown). Alternatively, elastomer seals can also be used.

In an electrochemically active region 18, the first individual plates 2a have a flow field 17 with structures for guiding a reaction medium along the outer side of the individual plate 2a on their outer side facing the viewer of FIG. 2. These structures are provided in FIG. 2 by a plurality of webs and channels which run between the webs and which are delimited by the webs. On the outer side of the separator plates 2 facing the viewer in FIG. 2, the first individual plates 2a also each have a distribution and collection region 20. Distribution or collection regions 20 in each case comprise structures which are configured to distribute a medium introduced proceeding from a first of the two through-openings 11b into the distribution region 20 over the active region 18 or to collect or combine a medium flowing proceeding from the active region 18 towards the second of the through-openings 11b. The fluid-guiding structures 29 of both distribution or collection regions 20 are likewise provided in FIG. 2 by webs and channels which run between the webs and which are delimited by the webs. In the following text, only the distribution region 20 will be discussed for the sake of simplicity; the corresponding statements can equally apply to a collection region 20.

The sealing beads 12a-12c have passages 13a-13c, of which the passages 13a are formed both on the underside of the upper individual plate 2a and on the upper side of the lower individual plate 2b, while the passages 13b are formed in the upper individual plate 2a and the passages 13c in the lower individual plate 2b. For example, the passages 13a, which are designed as localized elevations of the bead, allow a passage of coolant between the through-opening 12a and the distribution region 20, so that the coolant enters the distribution region between the separator plates or is led out of the collection region 20. Furthermore, the passages 13b enable passage of hydrogen between the through-opening 12b and the distribution region on the top side of the upper individual plate 2a, these passages 13b are characterized by perforations which face the distribution region and which run obliquely with respect to the plate plane. Thus, for example hydrogen flows through the passages 13b from the through-opening 12b to the distribution region on the top side of the upper individual plate 2a or in the opposite direction from the collection region. The passages 13c enable passage of for example air between the through-opening 12c and the distribution region, such that air passes into the distribution region on the bottom side of the lower individual plate 2b or is conducted out of the collection region. The associated perforations are not visible here.

The first individual plates 2a also each comprise a further sealing arrangement in the form of a perimeter bead 12d which runs around the flow field 17 of the active region 18, the distribution and collection regions 20 and the through-openings 11b, 11c and seals them off from the through-opening 11a, e.g from the coolant circuit, and from the environment of the system 1. The second individual plates 2b each comprise corresponding perimeter beads. The structures of the active region 18, the distribution structures of the distribution region and of the collection region 20 and the sealing beads 12a-d are each formed in one part with the individual plates 2a and are each formed into the individual plates 2a, e.g. in an embossing or deep-drawing process or by means of hydroforming. The same applies to the corresponding structures of the second individual plates 2b.

The two through-openings 11b or the lines formed by the through-openings 11b through the plate stack of the system 1 are each fluidically connected to one another via passages 13b in the sealing beads 12b, via the distribution structures of the distribution or collection region 20 and via the flow field 17 in the active region 18 of the first individual plates 2a facing the observer in FIG. 2. Similarly, the two through-openings 11c or the lines formed by the through-openings 11c through the plate stack of the system 1 are each fluidically connected to one another via corresponding bead passages, via corresponding distribution and collection structures and via a corresponding flow field on an outer side of the second individual plates 2b facing away from the observer in FIG. 2. By contrast, the through-openings 11a or the lines formed by the through-openings 11a through the plate stack of the system 1 are each fluidically connected to one another via a cavity 19 enclosed by the individual plates 2a, 2b. This cavity 19 serves in each case for conducting a coolant through the separator plate 2, for instance for cooling the electrochemically active region 18 of the separator plate 2.

FIG. 3 schematically shows a section through a portion of the plate stack 6 of the system 1 from FIG. 1, the section plane being oriented in the z-direction and thus perpendicular to the plate planes of the separator plates 2. In FIG. 3, the sectional plane runs along a bent section, along the sectional line C-C in FIG. 2.

The structurally identical separator plates 2 of the stack each comprise the above-described first metallic individual plate 2a and the above-described second metallic individual plate 2b. Structures for guiding media along the outer surfaces of the separator plates 2, here in particular in each case in the form of webs and channels delimited by the webs, are apparent. In particular, channels on the surfaces of individual plates 2a, 2b which adjoin one another, said surfaces being directed away from one another, and cooling channels in the cavity 19 between individual plates 2a, 2b which adjoin one another are shown. Between the cooling channels, both in the distribution or collection region 20 and in the active region 18, the two individual plates 2a, 2b lie one on top of the other in a contact region 24 and are connected to one another in said contact region in each case, in the present example by means of laser weld seams.

A respective membrane electrode assembly (MEA) 10 known for example from the prior art is arranged between adjacent separator plates 2 of the stack. The MEA 10 typically comprises a membrane, e.g. an electrolyte membrane, and an edge portion 15 connected to the membrane 14. For example, the edge portion 15 can be bonded to the membrane 14, e.g. by an adhesive connection or by lamination.

The membrane of the MEA 10 extends in each case at least over the active region 18 of the adjacent separator plates 2 and enables a proton transfer there over or through the membrane 14. However, the membrane does not reach into the distribution or collection region 20. The edge portion 15 of the MEA 10 serves in each case for positioning, fastening and sealing the membrane between the adjoining separator plates 2.

The edge portion 15 in each case covers the distribution or collection region 20 of the adjoining separator plates 2. The edge portion 15 can also extend outwards beyond the perimeter bead 12d and adjoin or protrude beyond the outer edge region of the individual plates 2a, 2b (see FIG. 2).

Furthermore, gas diffusion layers 16 may additionally be arranged in the active region 18. The gas diffusion layers 16 enable direct flow to the membrane over the greatest possible region of the surface of the membrane and can thus improve the transfer of protons via the membrane. The gas diffusion layers 16 may be arranged, for example, in each case on both sides of the membrane in the active region 18 between the adjoining separator plates 2. The gas diffusion layers 16 may be, for example, formed from a fiber felt or comprise a fiber felt.

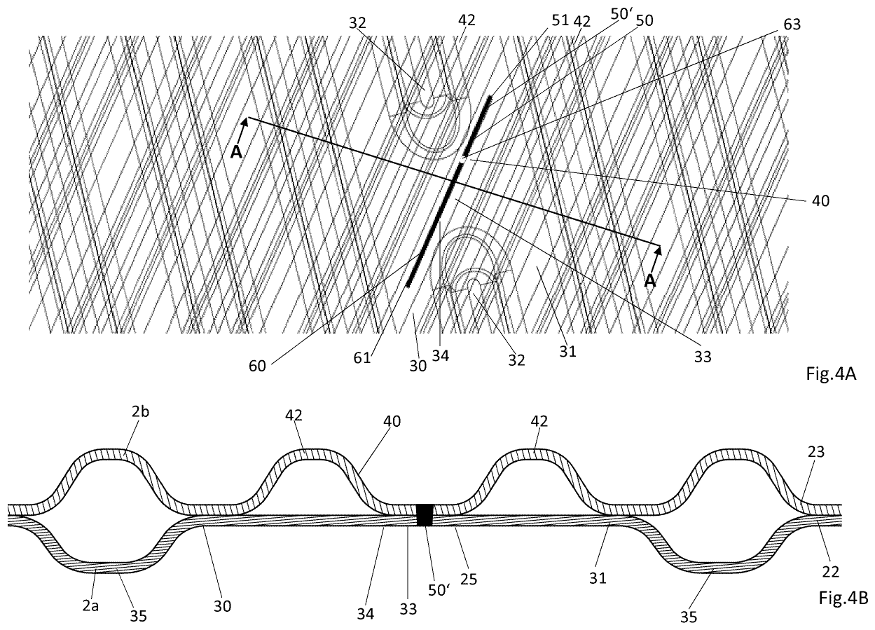

Reference is also made to FIG. 4A, where a section of the distribution or collection region 20 is shown. The distribution or collection regions 20 of the second individual plate 2b and of the first individual plate 2a are connected to one another in certain regions along their mutually facing rear sides in a materially bonded manner, here for instance by laser welded joints 50′. As indicated in FIG. 4A, channels 30, 31 and webs 32 of the distribution region 20 of the first individual plate 2a and channels 40 and webs 42 of the distribution region 20 of the second individual plate 2b run crossed in parallel planes to one another. In the example of FIG. 4A, the channels 30, 31 and the webs 32 in the distribution region 20 of the first individual plate 2a form an intersection angle of approximately between 40° and 60° or between 120° and 140° with the channels 40 and the webs 42 in the distribution region 20 of the second individual plate 2a.

Regions of the webs of the first individual plate 2a in which a vertical projection of one of the channels of the second individual plate 2b onto the first individual plate 2a crosses one of the webs of the first individual plate 2a are called crossing regions 33 of the webs 32 of the first individual plate 2a. Fully correspondingly, regions of the webs of the second individual plate 2b in which a vertical projection of one of the channels 30, 31 of the first individual plate 2a onto the second individual plate 2b crosses one of the webs of the second individual plate 2b are called crossing regions of the webs of the second individual plate 2b.

As described in the introduction, a crucial disadvantage of known separator plates 2 is that, in those regions in which the channels of the individual plates 2a, 2b run in a crossed manner as described here, the individual plates 2a, 2b of the separator plate 2 can typically be connected only along very small contact regions, specifically precisely at those locations where the mutually facing rear sides of the channel bases of the two individual plates 2a, 2b cross one another.

In order to at least partially address this problem, publication WO 2017/029158 A1 proposes to enlarge the contact regions of the plates 2a, 2b by lowering the webs 32 of the first individual plate 2a, as shown in FIG. 4A and FIG. 4B of the present publication, in some of the intersection regions 33 in a lowering region 34 in such a way that the rear side of the first individual plate 2a facing the second individual plate 2b is in contact with the rear side of the bottom of the corresponding channel 40 of the second individual plate 2b in these intersection regions 33 and is connected in a material-locking manner, here for example by laser welded joints 50′. The contact surfaces along which the rear sides of the individual plates 2a, 2b are in contact and are or can be connected to one another in the distribution regions 20 can thus be increased in size considerably.

Specifically, the two individual plates 2a, 2b are or can be connected to one another not only at the locations where the channels 30, 31 of the first individual plate 2a and the channels 40 of the second individual plate 2b cross one another and their rear sides thus come into contact with one another but additionally in the crossing region 33 of the web 32 between the channels 30, 31 of the first individual plate 2a, where the lowered portion 34 of the web 32 provides a larger contact surface between the rear sides of the individual plates 2a, 2b. This increases the stability of the connection between the individual plates 2a, 2b and places lower demands on the spatial accuracy of the selected connection technique. The reject rate during the production of the separator plate 2 and the service life of the separator plate 2 in operation can thus be improved.

Due to the fact that the first channels 30, 31 running on either side of the web 32 are fluidically connected by way of the lowered portion 34 of the web 32, the positioning of the lowered portion 34 along the first channels 30, 31 can also be utilized in a targeted manner in order to influence the flow behavior of the media in the first channels 30, 31 and in the intermediate space 19 between the individual plates 2a, 2b.

Despite the above measures, pressure pulsation tests carried out by the applicant have shown that a welded joint can form a weak point in the separator plate 2. When high fluid pressures are applied, a welded joint can sometimes crack at its start and end points.

The present disclosure has therefore been devised in order to further increase the durability of separator plates 2. In particular, the use of a welded joint 50′ is intended to achieve a higher lifespan, at least with regard to the operational pulsation of the pressure of the media present, such as the coolant. The welded joint 50′ extends longitudinally from a first end 51 located in a first end region to a second end 61 located in a second end region. The welded joint 50 forms an end crater 63 between the first end 51 and the second end 61. The end crater 63 is spaced from the first end 51 of the welded joint 50′ and from the second end 61 of the welded joint 50′.

The welded joint 50′ has a first weld seam 50, a second weld seam 60 and an end crater 63. The first weld seam 50 was welded in a first direction starting at the first end 51 in the direction of the second end 61. The second weld seam 60 was welded in a second direction starting at the second end 61 in the direction of the first end 51. The length of the first weld seam 50, measured from the first end 51 in the direction of the second end, extends beyond the end crater 63, but not as far as the second end 61. The second weld seam 60 begins at the second end and extends around the end crater 63 to the end of the end crater 63 that is closer to the first end 51. The end crater 63 of the welded joint 50′ is the end crater that was formed by stoppage at the end of the second weld seam 60 during welding of the second weld seam 60. An end crater of the first weld seam 50 was traversed by the second weld seam 60 and is therefore not visible in FIG. 4A. In the example shown in FIG. 4A, the first weld seam 50 and the second weld seam 60 run along a straight line. In other examples, the first weld seam 50 and/or the second weld seam 60 may comprise curved portions.

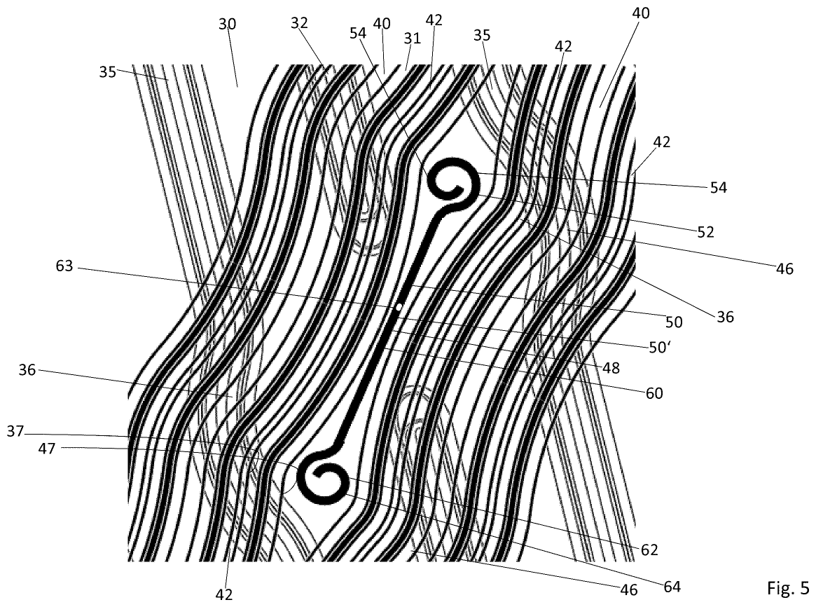

While the welded joint 50′ shown in FIG. 4A is straight over its entire length, the welded joint 50′ as shown in FIG. 5 can comprise at least one curved section 54, 64, which serves to stabilize the welded joint 50.

It will be understood that, although FIG. 4A only shows the welded joint 50′ in a rectilinear form, the welded joints 50′ may alternatively be curved or partially curved. An exemplary embodiment of a welded joint 50′ with two curved sections 54, 64 is shown in FIG. 5.

Specifically, the welded joint 50′ of FIG. 5 has a first end region 52 and a first curved section 54. The first curved section 54 extends and is curved in such a way that a virtual straight line running vertically through the first end region 52 intersects the welded joint 50 at least twice, for example in the end region 52 and in the region of the first curved section.

Alternatively or additionally, the welded joint 50′ has a second end region 62 and a second curved section 64, wherein the second curved section 64 extends and is curved in such a way that a virtual second straight line extending vertically through the second end region 62 intersects the welded joint 50′ at least twice.

The virtual straight line is an imaginary line which is drawn vertically through the end region 52, 62. Depending on the design of the curved region, the welded joint is intersected more or less often by the virtual straight line. In other words, part of the welded joint 50 runs next to the end region 52, 62, in order to reinforce the latter. The curved section 54, 64 can have various shapes, for example: circular, spiral, at least partially following the shape of an ellipse or an oval, or hairpin-shaped.

The end region 52, 62 of the welded joint 50 is defined in such a way that it marks the point where the welding tool was applied-the start of a welding step. The curved region 54, 64 stiffens the end region 52, 62 locally, as a result of which the end region 52, 62 can be stabilized. At least certain portions of the curved region 54, 64 run transversely with respect to the end region and optionally also transversely with respect to the flow direction of the fluid. Instead of a narrow end of the welded joint 50′, as shown in FIG. 4A, this results in a significantly wider contact surface compared to the width of the welded joint 50′, see FIG. 5, which cannot be peeled open by the pressure pulsation in the context of the operational pressure fluctuations or can be peeled open with considerable difficulty. Peeling open or tearing of the end region 52, 62 is much less likely as a result.

The welded joint 50′ can have a straight central section that connects to the first curved section 54 and/or the second curved section 64, see FIG. 5. The end crater 63 is arranged in the central section in one example. Instead of a rectilinear central section, a corrugated or non-rectilinear central section may also be arranged between the two curved sections 54, 64 or may adjoin a curved section 54, 64. At least one section of the central section can also be straight and at least one other section of the central section can be non-straight. The middle section can have a length that is at least 40%, at least 50% or at least 60% of the length of the entire welded joint 50′. A length of the middle section can be, for example, 2.5 mm with a total length of the welded joint 50′ of approx. 3.5 mm, wherein the latter does not represent the unwinding length, but the extension along a straight line that runs parallel to the straight middle section. The end region 52, 62, for example the straight portion thereof, may, for example, extend substantially parallel to the central portion and/or form an extension of the central portion.

The curved sections 54, 64 require more space in the lateral direction-e.g. transversely to the longitudinal extension of the channel 40-than the straight weld line 50′ of FIG. 4A. In the cramped conditions of the channels in FIG. 4A, this space is not always available, which may have a restricting effect on the geometry of the welded joint 50′. It is optionally possible for the channels 30, 31, 40 to be adapted, in terms of their geometry, to the welded joint 50′, as a result of which channels 30, 31, 40 and welded joint 50 can be matched to one another. This can be seen in FIG. 5.

It is apparent in FIG. 5 that the first channels 30, 31 each comprise a first channel widening 36, in order to increase the size of the contact zone 25 of the individual plates 2a, 2b and to provide space for the welded joint 50, in particular the curved portions 54, 64 of the welded joint 50′. The respective channel widening 36 comprises a concave portion 37 in a web 35 which is adjacent to the web 32 and which delimits the respective channel 30, 31, the concave portion 37 being able to be formed as a bulge in the web 35. Here, a width of the web 35, measured perpendicularly with respect to the longitudinal extent of the channel 30, 31, can remain substantially constant. Since the second channel 40 extends in an angled manner with respect to the first channels 30, 31, the channel widenings 36 may be arranged offset relative to one another in the longitudinal direction or direction of extent of the channels 30, 31. The first individual plate 2a is thus connected to the second individual plate 2b, in particular to the channel base of the second channel 40, in the region of the first channel widenings 36 by means of the welded joint 50′, in particular the curved portions 54, 64 of the welded joint.

It is indicated in FIG. 5 that the second channel 40 comprises at least one second channel widening 46 in a second region adjoining the crossing region 33 of the web 32. The channel widening 46 may be formed as a concave portion 47 or concave bulge 47 in the web 42 delimiting the channel 40. The contact zone 25 of the individual plates 2a, 2b may at least partially extend into the region of the second channel widening 46. Provision may thus be made for the second individual plate 2b to be connected to the first individual plate 2a in the region of the second channel widening 46 by means of the welded joint 50′, in particular the curved portions 54, 64. Optionally, the second channel 40 can have the aforementioned second duct widening 46 on both sides of the intersection region 33. In some instances, the second channel 40 comprises, in the crossing region 33 between the second channel widenings 46, a channel tapering 48 in relation to the channel widenings 46. Here, the channel tapering 48 may be tapered merely in relation to the channel widenings 46, and may have a width which corresponds to a width of the channel 40 outside of the channel widenings 46. It may be advantageous for the first channel widening 36 and the second channel widening 46 to at least partially overlap in the contact zone 25. In this case, the welded joint 50′ may be provided in the overlapping region of the mentioned channel widenings 36, 46. The central section can run essentially parallel to the second channel 40. It is also possible for the middle portion to extend at least between the two channel widenings 46. In particular, the central section can be provided at least in the lowered region 34 of the web 32. The end region 52, 62 and the curved portion 54, 64 may be arranged in the respective channel bases of the channels 30, 31, 40, and in particular in the region of the channel widenings 36, 46.

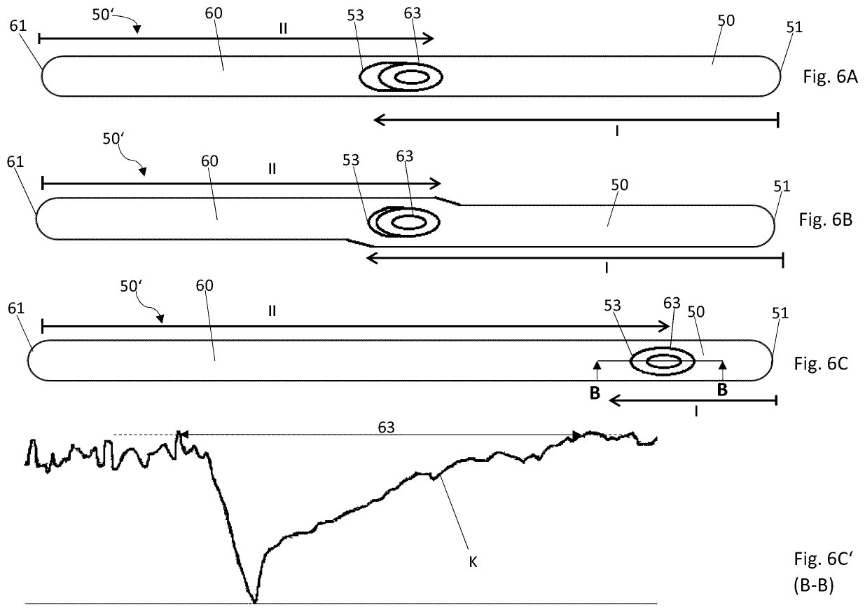

FIGS. 6A to 6C show various configurations of a welded joint 50′ that can be used, for example, in a separator plate 2 as shown in FIG. 4 or FIG. 5. The welded joint 50′ of FIG. 6A comprises a first weld seam 50, which was welded in a first direction, characterized by the direction of arrow I, starting at the first end 51 of the welded joint 50′ along a first imaginary straight line. The first weld seam 50 ends in a first end crater 53, which was only drawn in FIG. 6A for illustration purposes, but is no longer visible in the welded joint 50′. The length of the first weld seam 50 is illustrated by the length of the directional arrow I. The welded joint 50′ of FIG. 6A comprises a second weld seam 60, which was welded in a second direction, characterized by the direction of arrow II, starting at the second end 61 of the welded joint 50′ along the same first imaginary straight line. The second weld seam 60 overlaps the first weld seam 50 and was welded in such a way that it extends beyond the first end crater 53. The second weld seam ends in a second end crater 63. In FIG. 6A, the end crater 63 is arranged substantially centrally between the first end 51 and the second end 63. The length of the second weld seam 60 is illustrated by the length of the directional arrow II. A width of the first weld seam 50 essentially corresponds to a width of the second weld seam 60 and a width of the welded joint 50′.

The welded joint 50′ of FIG. 6B comprises a first weld seam 50, which was welded in a first direction, characterized by the direction of arrow I, starting at the first end 51 of the welded joint 50′ along a first imaginary straight line. The first weld seam 50 ends in a first end crater 53, which was only drawn in FIG. 6B for illustration purposes, but is no longer visible in the welded joint 50′. The length of the first weld seam 50 is illustrated by the length of the directional arrow I. The welded joint 50′ of FIG. 6B comprises a second weld seam 60, which was welded in a second direction, characterized by the direction of arrow II, starting at the second end 61 of the welded joint 50′ along a second imaginary straight line. The first and second imaginary straight lines correspond to the center lines of the first and second weld seams 50, 60. The first and second imaginary straight lines run parallel to each other, but are at a distance from each other. The second weld seam 60 overlaps the first weld seam 50 and was welded in such a way that it extends beyond the first end crater 53. The second weld seam ends in a second end crater 63. The end crater 63 is also arranged substantially centrally between the first end 51 and the second end 61 in FIG. 6B. The length of the second weld seam 60 is illustrated by the length of the directional arrow II. A width of the first weld seam 50 essentially corresponds to a width of the second weld seam 60. The width of the welded joint 50′ varies. In an overlap region where the first weld seam 50 and the second weld seam 60 overlap, the welded joint has a maximum width.

The welded joint 50′ of FIG. 6C essentially corresponds to the welded joint of FIG. 6A, whereby the end crater 63 exactly overlaps the end crater 53 and is arranged closer to the first end 51 than to the second end 61. In the present case, the end crater 63 is approximately one end crater length away from the first end 51.

FIG. 6C′ schematically illustrates a height profile along the section B-B indicated in FIG. 6C through the welded joint 50′ and the end crater 63 of FIG. 6C. The graph K shows a height profile of the weld seam over a section of its length in the region of the end crater 63. The double arrow illustrates the length of the end crater 63. In the region outside the end crater 63, the surface of the weld seam is noisy, while the surface in the end crater 63 is smoother.

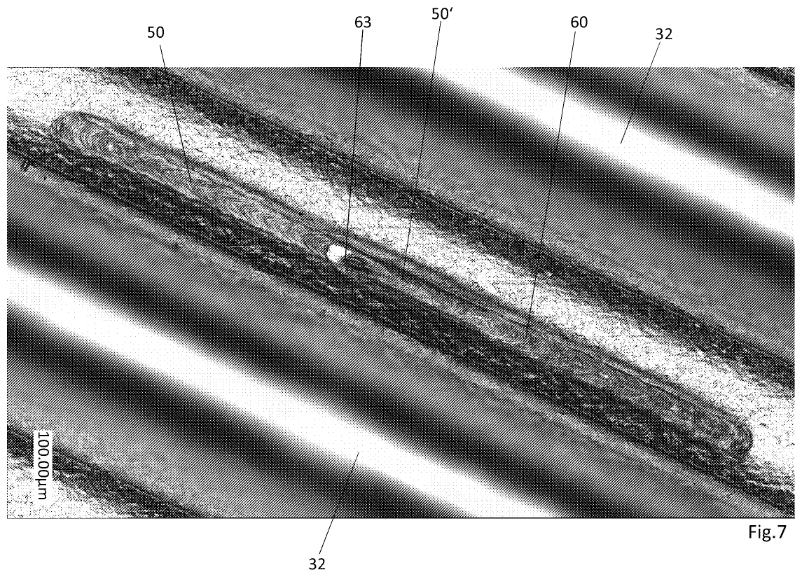

FIG. 7 shows a section of a top view of an individual plate of the separator plate 2 according to FIG. 4A, looking from a beam entry side, e.g. plate 2b. The welded joint 50′ shown corresponds to the welded joint in FIG. 6A. The first weld seam 50 has first imbricated weld solidification lines in a region that are not overlapped by the second weld seam, while the second weld seam has second imbricated weld solidification lines the imbricated pattern of which runs in the opposite direction to the imbricated pattern of the first imbricated weld solidification lines.

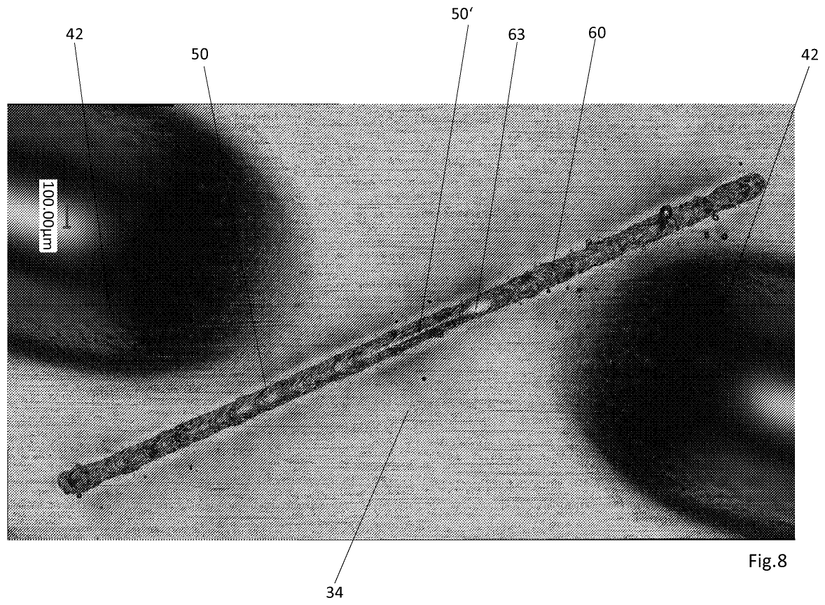

FIG. 8 shows a section of a top view of the individual plate of the separator plate 2 of FIG. 7, including the welded joint 50′, looking onto the beam exit side, e.g onto the rear side of the individual plate 2a. The welded joint is located in the region of the lowering 34 of the web 32.

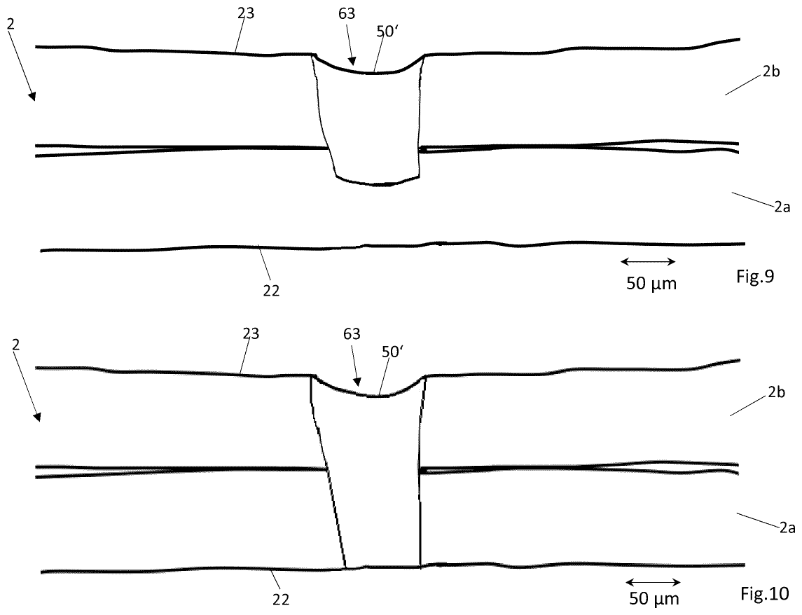

FIGS. 9 and 10 each show a schematic section through the separator plate 2 in the region of an exemplary welded joint 50′. The sections are essentially perpendicular to the direction of the welded joint 50′. While FIG. 9 shows a region in which the welded joint 50′ extends through the entire material thickness of the second plate 2b, but only through approximately one third of the material thickness of the first plate 2a, the weld seam 50′ in FIG. 10 is shown in a region that extends completely through the material thickness of the second and first plates 2b, 2a. The welded joint 50′ thus extends here from the outer side 22 of the first plate 2a to the outer side 23 of the second plate 2b. As shown in FIG. 9, the welded joint can also be visible on only one of the two outer sides 22, 23 and not extend all the way to the respective other outer side 23, 22 As indicated in FIGS. 9 and 10, the first individual plate 2a and/or the second individual plate 2b can have a thickness of at least 50 μm, in particular at least 70 μm. The thickness of the plates may also be at most 200 μm, in particular at most 150 μm, in particular at most 100 μm. Given these relatively small thicknesses, it may be that the welded joint 50′, as shown in FIG. 9, is in the form of a through-weld.

It should be mentioned again that the separator plate 2 described above and shown in the figures is often called a bipolar plate in applications in a fuel cell system 1.

Furthermore, an electrochemical system 1 is proposed, for example of the type shown in FIG. 1, which comprises a plurality of stacked separator plates 2 or bipolar plates of the type described here.

It is understood that features of the embodiments of the figures described above can be combined with each other or claimed individually, provided that they do not contradict each other.

### LIST OF REFERENCE SIGNS

1 electrochemical system
2 separator plate or bipolar plate
2a individual plate
2b individual plate
3 end plate
4 end plate
5 media port
6 stack
7 z-direction
8 x-direction
9 y-direction
10 membrane electrode assembly
11a-c through-openings
12a-d sealing beads
13a-c passages
14 membrane
15 edge portion
16 gas diffusion layer
17 Flow field
18 electrochemically active region
19 cavity
20 distribution or collection region
22 outer side of the first individual plate 2a
23 outer side of the second individual plate 2b
25 contact zone
29 Fluid-guiding structures of the distribution or collection region
30 First channel
31 First channel
32 Web
33 Crossing region
34 Lower portion of the web
35 Web
36 First channel widening
37 Concave region
40 Second channel
42 Web
46 Second channel widening
47 Concave region
48 Channel tapering
50′ welded joint
50 first weld seam
51 first end of the welded joint
52 first end region
53 end crater of the first weld seam
54 First curved portion
60 second weld seam
61 second end of the welded joint
62 second end region
63 end crater of the second weld seam and the welded joint
64 Second curved portion
K graph

1. A separator plate for an electrochemical system, comprising a first individual plate and a second individual plate which is connected to the first individual plate, wherein the first individual plate and the second individual plate contact one another in a contact zone,
wherein the first individual plate comprises two first channels for conducting media, which are formed in the first individual plate, which run next to one another and which are separated from one another at least in sections by a web formed between the first channels;
wherein the second individual plate comprises a second channel for conducting media, which is formed in the second individual plate; and
wherein the web formed between the first channels, and the second channel formed in the second individual plate, are configured and arranged in such a way that a projection of the second channel onto the first individual plate perpendicular to a plane of the first individual plate crosses the web along a crossing region of the web;
wherein the web is lower in the crossing region of the web, such that the first channels running on either side of the web are fluidically connected by way of a lower portion of the web, and
wherein a rear side of a base of the lower portion, said rear side facing the second individual plate, is connected to a rear side of the base of the second channel, said rear side facing the first individual plate, in the contact zone by means of a welded joint,
wherein the welded joint extends longitudinally from a first end located in a first end region to a second end located in a second end region, wherein the welded joint forms an end crater between the first end and the second end and the end crater is spaced from the first end and from the second end.

2. The separator plate according to claim 1, wherein the welded joint does not form the end crater in the first end region and/or in the second end region.

3. The separator plate according to claim 1, wherein the end crater is located in a central 85% between the first and the second end of the welded joint.

4. The separator plate according to claim 1, wherein the welded joint has in the first end region, first imbricated weld solidification lines the imbricated pattern of which extends in a first direction and has, in the second end region, second imbricated weld solidification lines the imbricated pattern of which extends in a second direction opposite to the first direction.

5. The separator plate according to claim 1, wherein the welded joint comprises a first weld seam extending from the first end of the welded joint towards the second end of the welded joint, encompassing the end crater, and beyond the end crater, and the welded joint comprises a second weld seam which extends from the second end of the welded joint in a direction of the first end of the welded joint, encompassing the end crater, to an end of the end crater facing the first end of the welded joint.

6. The separator plate according to claim 5, wherein the welded joint is formed in such a way that the first weld seam at least partly overlaps the second weld seam in an overlap region.

7. The separator plate according to claim 5, wherein the end crater has a distance to the first end and/or to the second end of the welded joint of at least 20% and/or of at most 1000% of a width of the first weld seam and/or the second weld seam.

8. The separator plate according to claim 5, wherein the end crater has a length which corresponds to at least 25% and/or at most 600% of a width of the first weld seam and/or the second weld seam.

9. The separator plate according to claim 7, wherein the first weld seam has first imbricated weld solidification lines the imbricated pattern of which extends in a first direction at least in sections and the second weld seam has second first imbricated weld solidification lines the imbricated pattern of which extends in a second direction at least in sections, wherein the second direction is opposite to the first direction.

10. The separator plate according to claim 6, wherein the overlap region has a length which corresponds to at least 400% of a length of the end crater.

11. The separator plate according to claim 6, wherein the overlap region has a length corresponding to at most 80% of a length of the welded joint.

12. The separator plate according to claim 6, wherein the overlap region has a length corresponding to at least 10% of a length of the welded joint.

13. The separator plate according to claim 1, wherein the welded joint comprises a straight section or has a straight course.

14. The separator plate according to claim 1, wherein the welded joint is a laser welded joint.

15. The separator plate according to claim 1, wherein the welded joint is formed as a continuous welded joint.

16. The separator plate according to claim 1, wherein the welded joint has a shape which is designed such that it can be formed by applying a welding tool and/or welding laser beam at most one time.

17. The electrochemical system comprising a plurality of stacked separator plates according to claim 1.

18. The separator plate according to claim 3, wherein the end crater is located in a central 70% between the first and the second end of the welded joint.

19. The separator plate according to claim 4, wherein the first imbricated weld solidification lines the imbricated pattern of which extends in the first direction is in a region from the first end of the welded joint to the end crater, and the second imbricated weld solidification lines the imbricated pattern of which extends in the second direction is in a second region from the second end of the welded joint to the end crater.

20. The separator plate according to claim 7, wherein the distance to the first end and/or to the second end of the welded joint is at least 50% and/or at most 800% of the width of the first weld seam and/or second weld seam.
